(19) United States
(12) Patent Application Publication
(10) Pub. No.: US 2008/0104538 A1
(43) Pub. Date: May 1, 2008

(54) METHOD OF OPERATING POPUP WINDOW OF BROWSERS THROUGH REMOTE CONTROLLER

(76) Inventor: Li WeiXin, Shanghai (CN)

Correspondence Address: NIKOLAI & MERSEREAU, P.A., 900 SECOND AVENUE SOUTH, SUITE 820, MINNEAPOLIS, MN, 55402, US

(21) Appl. No.: 11/553,311

(22) Filed: Oct. 26, 2006

(51) Int. Cl. G06F 3/00

(52) U.S. Cl. 715/808; 715/740

(57) ABSTRACT

The present invention provides a method to operate a popup window of browsers through a remote controller adopted for use on a remote controller and an information appliance equipped with a browser. The method uses the remote controller to substitute a mouse or keyboard to maneuver operation of the popup window of a browser, thereby to facilitate operation and reduce production cost, and improve market acceptance.

### BACKGROUND OF THE INVENTION

1. Field of the Invention

The present invention relates to a method of operating a popup window of browsers through a remote controller and particularly to a method of using a remote controller on an information appliance platform to facilitate operation of the popup window.

2. Description of the Prior Art

In the present digital age technology enables people to live more comfortable and convenient. Aside from computers that many people deem indispensable, these days a new generation of technology home appliances—information appliances—that couple the conventional home appliances and digital and network technologies have been developed to further improve people's living comfort and convenience. Information appliance is an information household product equipped with consumer electronic functions. It offers a lower technical barrier between people and machine, and makes application functions more useful. It provides many benefits, such as simple operation, stable function, easy maintenance and installation, easy to learn and use. Any person who does not know computer can access networks through a simple operation by depressing button keys of a remote controller to enjoy the excellent services of network functions such as purchasing on the network. In order to make it accessible to most people, design of the information appliance especially focuses on operation simplicity. Hence it has a great appeal to the general consumers. Nowadays the information appliance has been expanded to many types of home appliances such as TV sets, refrigerators, washing machines, microwave ovens and the like. They become network home appliances equipped with network access function.

In order to enable most people to access networks to do purchase, online network purchase on the information appliance is controlled through button keys of a remote controller. In a browser displayed on a LCD screen, online purchase is done by entering a Website to select a required article. About prior arts, a method for linking an information appliance to the Internet. The information appliance is communicated with a processor. A kind of the prior arts generally includes a procedure as follow: A. install a first firmware on the information appliance, the first firmware includes an appliance virtual Internet Protocol address; B. install a second firmware on the processor, the second firmware includes a processor virtual Internet Protocol address to communicate with the first firmware. C. the processor sends a multicast packet to the information appliance through the processor virtual Internet Protocol address, the multicast packet includes a processor Internet Protocol address of the processor; D. the information appliance receives the multicast packet; and E. the first firmware sets an appliance Internet protocol address, a netmask and a gateway of the information appliance based on the processor network protocol address, thereby the information appliance can be linked to the Internet.

However, recently Macromedia Co. of U.S.A. has designed a two-dimensional animation software—Flash which is widely used on Internet Webpage. A flash animation through Vector Graphics consumes less storage space. Hence it is widely used to design Internet Webpage. This results in inoperable condition when the information appliance accesses the Flash webpage. The most common problem is that after a user has entered the Flash webpage and finished operation on a popup window in the webpage, the cursor controlled by the remote controller cannot leave the popup window to operate other portions of the webpage. This is especially true for the general browsers such as MS IE or Mozilla/Firefox. They all do not permit directional keys to maneuver the popup window. Moreover, after having entered the popup window of the Flash webpage, if the page size to be displayed on the popup window is too big and cannot be fully displayed, the cursor cannot be moved by the remote controller to get a full display of the page.

Some information appliances perform operation of the popup window in the Flash webpage through a wireless mouse, wireless track ball or wireless keyboard. Such an approach can prevent the problems set forth above. But the price of the wireless mouse, wireless track ball or wireless keyboard is much higher than the remote controller. Hence its market acceptance is lower. In addition, in terms of operation convenience of user interface, acceptance of the remote controller is much higher for users who are not familiar with computers.

As the present method of operating the popup window of information appliances adopts the wireless mouse, wireless track ball or wireless keyboard, market acceptances and convenience are not desirable, total solution is still wanted. There is a urgent need for a method to perform comprehensive operation of the popup window of information appliances.

### SUMMARY OF THE INVENTION

The primary object of the present invention is to provide a method of operating a popup window of browsers through a remote controller to substitute a mouse or keyboard to maneuver operation of the popup window of a browser, thereby to facilitate operation and reduce production cost, and improve market acceptance.

The method according to the invention is adopted for use on a remote controller and an electronic device equipped with a browser. The method includes: entering a popup window of a browser; inspecting whether all page information have been presented on the popup window while an indicator is moved to the edge of the popup window; presenting non-display page information through operation of a remote controller in the event that not all page information were presented. Operation of the remote controller to present the non-display page information is done through directional keys and a confirmation key of the remote controller to execute control items of the popup window (such as button keys or function keys); and leaving the popup window of the browser after all page information have been presented on the popup window through operation of the remote controller.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the architecture of an embodiment of the invention;

FIG. 2 is a plane view of an embodiment of the remote controller of the invention;

FIG. 3 is a process flow of an embodiment of the invention;

FIG. 4 is a schematic view of an embodiment of a popup window in operating condition-1;

FIG. 5 is a schematic view of an embodiment of a popup window in operating condition-2; and

FIG. 6 is a schematic view of an embodiment of a popup window in operating condition-3.

### DESCRIPTION OF THE PREFERRED EMBODIMENTS

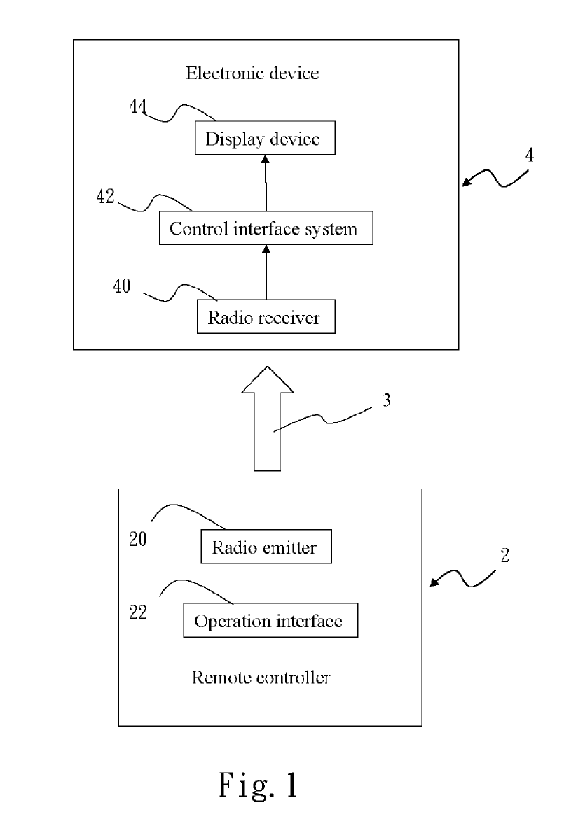

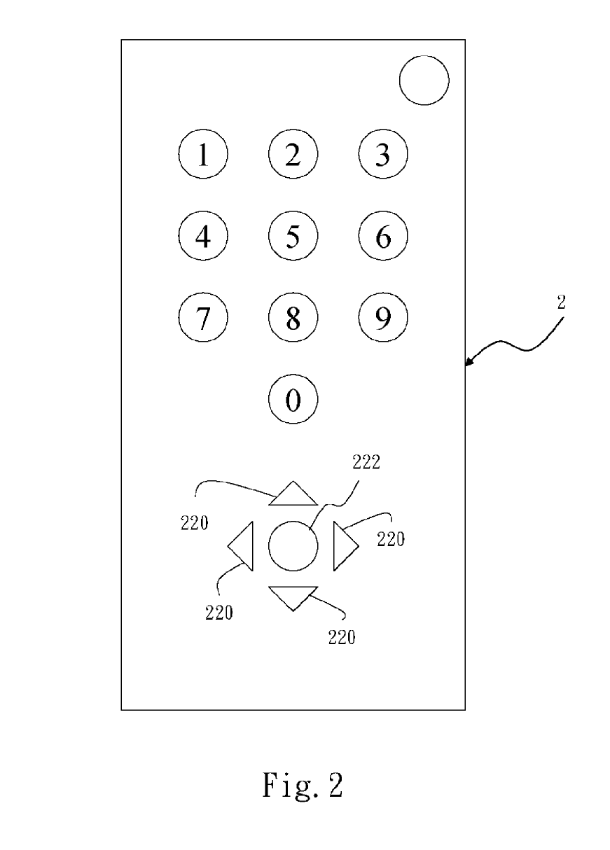

Refer to FIG. 1 for the architecture of an embodiment of the invention and FIG. 2 for a plane view of a remote controller of the invention. The method of operating a popup window of browsers through a remote controller according to the invention is adopted for use on a remote controller 2 and an electronic device 4. The remote controller 2 includes a radio emitter 20 and an operation interface 22. The operation interface 22 of the remote controller 2 has a plurality of directional keys 220 and a confirmation key 222.

The electronic device 4 allows users to transmit and receive information through networks, and perform information processing of calculation, comparison, selection, determination and the like. A preferable embodiment is to substitute the electronic device 4 with an information appliance or a computer linking to a network. The electronic device 4 includes a radio receiver 40 and a control interface system 42. The control interface system 42 controls operation of the electronic device 4 through the operation interface 22 of the remote controller 2. In the embodiment of the invention the remote controller 2 performs operations on the control interface system 42 through an object oriented program such as VB, PHP, JAVA, C++ or the like.

Moreover, in the embodiment of the invention the electronic device 4 may further include a display device 44 to display information for the electronic device 4 through graphics or texts. The display device 4 is preferably a LCD screen, plasma screen, LED panel or CRT screen. The control interface system 42 is connected to the radio receiver 40 and the display device 44 to receive signals from the radio receiver 40 to perform operations. Operation pictures of the control interface system 42 are displayed on the display device 44. The control interface system 42 includes a browser (not shown in the drawings). Users can control movement of the cursor of the browser of the control interface system 42 through the directional keys 220 of the remote controller 2, and send signals to the control interface system 42 through the confirmation key 222. The control interface system 42 transforms the signal of the confirmation key 222 to a left key signal of a mouse, and transmits to the popup window to maneuver control items and function table on the popup window.

Signal transmission of the radio emitter 20 and radio receiver 40 may adopt a wireless transmission means for radio transmission 3 such as radio signals, infrared light, supersonic waves, Bluetooth, RFID, laser or the like.

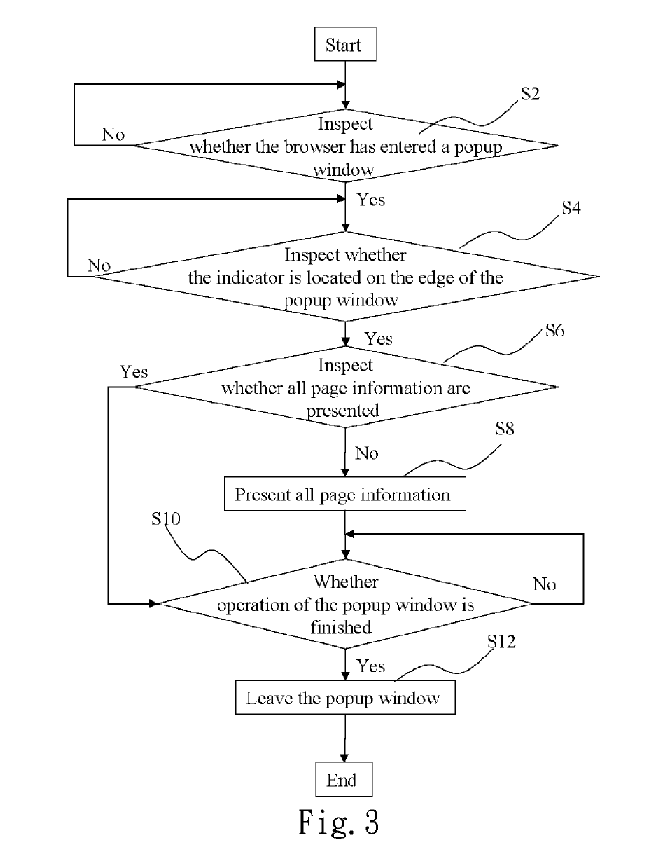

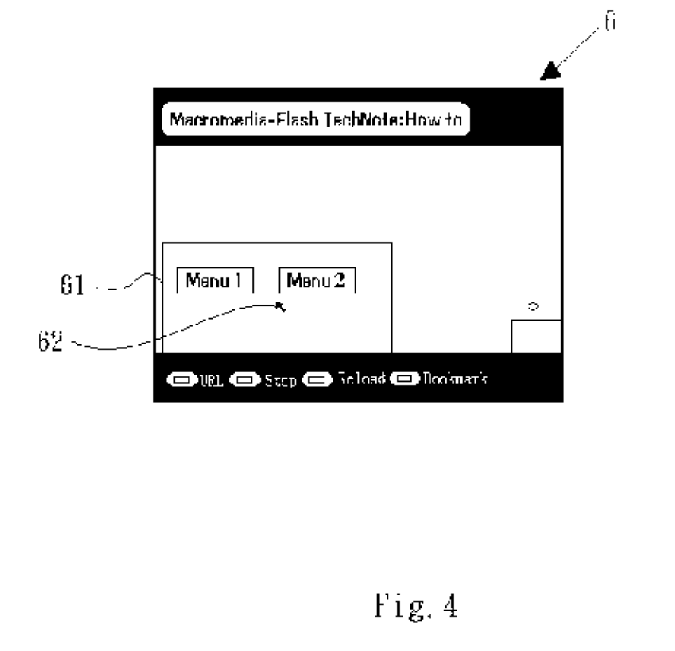

Refer to FIG. 3 for the process flowchart of an embodiment of the invention. The method of the invention includes: a step S2, inspecting an indicator 62 of the browser of the electronic device to determine whether entering a popup window 61 of a display 6 of browser exists (referring to FIG. 4); if negative, repeat the aforesaid inspection S2; the method of entering the popup window may be an active request from a user or a passive request of a forced command from a webpage information; maneuvering control items and function tables (such as MENU 1 and MENU 2 shown in FIG. 2) on the popup window through the remote controller and the pictures shown on the display device after entering of the browser into the popup window was confirmed; operation on the control items and function tables of the popup window is performed through the control interface system to transform the signal of the confirmation key of the remote controller to a left key signal of a mouse, and transmit to the popup window; inspecting whether the cursor of the browser is located on the edge of the popup window through control of the directional keys of the remote controller (S4); if negative, repeat the aforesaid inspection (S4); and inspecting whether all page information are presented on the popup window after the indicator of the browser is located on the edge of the popup window (S6); if positive, after the user has finished all operations of the popup window, through the signal transmitted from the confirmation key of the remote controller, the control interface system inquires whether the user has finished all operations of the popup window and wants to leave the popup window (S10); if negative, return to the operation page of the popup window until the next inquiry is raised; if positive, close the popup window (S12), and finish the process and return the indicator to the original operation page of the browser.

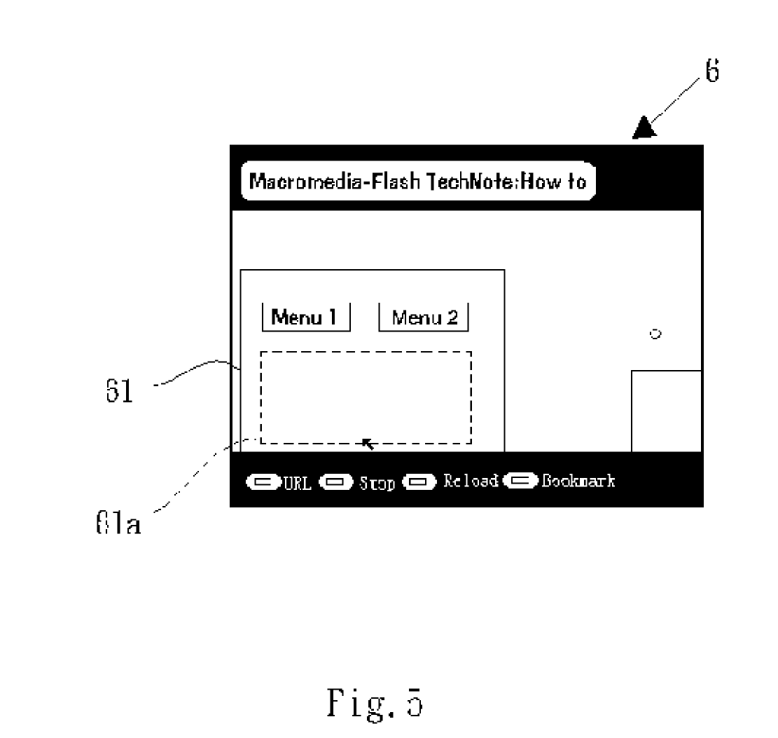

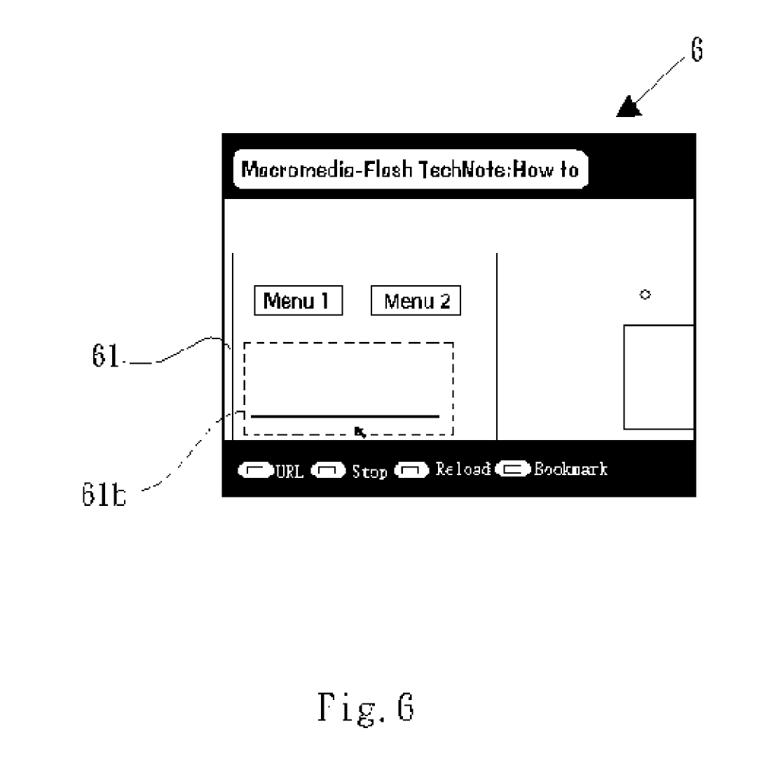

In the event that the popup window can only display a first status 61a, a part of the information, the page can be scrolled gradually (referring to FIG. 5) until all the information are fully presented (S8) (Referring to FIG. 6) while a second status 61b, a end part of the information, shows; then entering step S10.

In short, the method of the invention can operate the popup window of a browser through a remote controller, thus enable users who do not familiar with computers to overcome the inconvenience of using the conventional mouse or keyboard. Moreover, production cost is lower, and market acceptance is greater. Product competitiveness also is enhanced. In addition, the method of the invention provides page scrolling when the indicator is located on the edge of the popup window to fully present the information of the entire page. Hence operation is more convenient. As a result, the economic effectiveness of the information appliance increases.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method of operating a popup window of browsers through a remote controller to be used on a remote controller and an electronic device controlled by the remote controller, the remote controller having a plurality of directional keys and a confirmation key, the electronic device having a browser, the method comprising the steps of:
entering a popup window of the browser;
maneuvering an indicator of the browser to an edge of the popup window through the directional keys of the remote controller and inspecting whether all page information have been presented on the popup window;
presenting all page information on the popup window while the indicator of the browser is moved to the edge of the popup window through operation of the directional keys of the remote controller; and
leaving the popup window through operation of the confirmation key while the indicator of the browser is located on the edge of the popup window and all page information have been presented on the popup window.

2. The method of claim 1, wherein the step of entering a popup window of the browser is performed by either an active approach requested by a user or a passive approach upon a forced demand from a webpage information.

3. The method of claim 1, wherein the step of presenting all page information on the popup window is performed by scrolling page to gradually present all page information.

4. The method of claim 1, wherein the step of leaving the popup window through operation of the confirmation key is followed by closing the popup window and moving the indicator to an operation page of the browser.

5. The method of claim 1, wherein the step of entering a popup window of the browser includes operating control items and function tables in the popup window.

6. The method of claim 5, wherein the operating control items and function tables in the popup window is performed through a control interface system in the electronic device to transform a conformation key signal of the remote controller to a left key signal of a mouse and send the left key signal to the popup window.

7. A method of operating a popup window of browsers through a remote controller to be used on a remote controller and an electronic device controlled by the remote controller, the remote controller having an operation interface, the electronic device having a browser, the method comprising the steps of:
entering a popup window of the browser;
maneuvering an indicator of the browser to an edge of the popup window through the operation interface and inspecting whether all page information having been presented on the popup window; and
leaving the popup window through the operation interface while the indicator of the browser is located on the edge of the popup window and all page information have been presented on the popup window.

8. The method of claim 7, wherein the operation interface includes a plurality of direction keys and a confirmation key.

9. The method of claim 7, wherein the step of inspecting whether all page information having been presented on the popup window is followed by presenting all page information on the popup window through the operation interface when the indicator of the browser is located on the edge of the popup window and all page information are not yet presented on the popup window.

10. The method of claim 9, wherein the step of entering a popup window of the browser is performed by either an active approach requested by a user or a passive approach upon a forced demand from a webpage information.

11. The method of claim 9, wherein the step of presenting all page information on the popup window through the operation interface is performed by scrolling page to gradually present all page information.

12. The method of claim 9, wherein the step of leaving the popup window through the operation interface is followed by closing the popup window and moving the indicator to an operation page of the browser.

13. The method of claim 9, wherein the step of entering a popup window of the browser includes operating control items and function tables in the popup window.

14. The method of claim 13, wherein the operating control items and function tables in the popup window is performed through a control interface system in the electronic device to transform an operation interface signal to a left key signal of a mouse and send the left key signal to the popup window.
